(19) United States
(12) Patent Application Publication
(10) Pub. No.: US 2002/0089650 A1
(43) Pub. Date: Jul. 11, 2002

(54) Portable slide projector

(76) Inventor: Barry Wendall Stewart, Augusta, GA (US)

Correspondence Address: Law Offices of John D. Gugliotta, P.E., Esq., 202 Delaware Building, 137 South Main Street, Akron, OH, 44308, US

(21) Appl. No.: 09/758,097

(22) Filed: Jan. 10, 2001

(51) Int. Cl. G03B 21/00

(52) U.S. Cl. 353/43; 353/114

(57) ABSTRACT

A portable slide projector is provided for the portable projection of standard film slides. The projector has a housing of an overall size, shape and function of a flashlight. A rechargeable battery pack provides power to a lamp as controlled through a switch. A standard film slide of the common variety, is inserted into one of a series of aligned projection slots. The projection slots are supported by a linear carousel mechanism advances the aligned film slides into position to be projected.

### RELATED APPLICATIONS

The present invention was first described in Disclosure Document No. 472,904 filed on Apr. 21, 2000. There are no previously filed, nor currently any co-pending applications, anywhere in the world.

### BACKGROUND OF THE INVENTION

1. Field of the Invention

The present invention relates generally to projectors or viewers for transparencies and the like and, more particularly, to a portable projector including a linear carousel mechanism.

2. Description of the Related Art

There is a great abundance of methods to store and display personal visual images for the consumer. These methods not include the conventional chemical-based photograph, but now include digital pictures, analog videotape and lately, digital videotape. However, perhaps the highest quality means, the chemical-based slide picture, remains popular with only a few. Perhaps the only reason that it is not embraced by the majority is the difficulty in displaying pictures to others. A slide projector, coupled with a screen, a dark room, a source of electrical power and time to do so is required before others or even just the photographer can enjoy slide pictures in their full glory.

A search of the prior art did not disclose any patents that read directly on the claims of the instant invention; however, the following references were considered related.

The following patents disclose the ornamental design for a photographic slide projector:

U.S. Pat. No. D 253,708 issued in the name of Mankau

U.S. Pat. No. D 250,199 issued in the name of Mankau

U.S. Pat. No. 5,769,684 issued in the name of Lou describes a compact, low-cost, portable slide presentation toy.

U.S. Pat. No. 4,546,942 issued in the name of Winchel discloses a portable platform for slide projection.

U.S. Pat. No. D 400,553 issued in the name of Kung describes the ornamental design for a portable slide projector.

U.S. Pat. No. D 391,591 issued in the name of Kikuchi et al. discloses the ornamental design for a liquid crystal projector.

U.S. Pat. No. D 289,769 issued in the name of Geissler discloses the ornamental design for a folding rear projection slide viewer.

U.S. Pat. No. D 267,251 issued in the name of Link et al. describes the ornamental design for a briefcase microfiche reader.

Consequently, there is a need for a means by which photographic slides can be projected quickly and instantly virtually anywhere.

### SUMMARY OF THE INVENTION

It is therefore an object of the present invention to provide an improved slide projector.

It is a feature of the present invention to provide an improved slide projector that is small in size, making it easily portable.

Briefly described according to one embodiment of the present invention, a portable slide projector is provided for the portable projection of standard film slides. The invention has an overall size, shape and function of a flashlight. A rechargeable battery pack provides power to a lamp as controlled through a switch. A standard film slide of the common variety, is inserted into one of a series of aligned projection slots. The projection slots are supported by a linear carousel mechanism advances the aligned film slides into position to be projected. Various fixed lenses as well as an adjustable focusing lense then allows the image of the slide to be projected onto any flat surface.

An advantage of the present invention is that is can be easily transported and used do to its compact size.

Another advantage of the present invention is that it can illuminate color images onto any available flat surface.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side elevational view of portable projector including a linear carousel mechanism according to the preferred embodiment of the present invention shown herein with an access door in an open condition;

FIG. 2 is a perspective view thereof; and

FIG. 3 is a partial detail view of a lamp projection mechanism used therein.

### DESCRIPTION OF THE PREFERRED EMBODIMENTS

The best mode for carrying out the invention is presented in terms of its preferred embodiment, herein depicted within the Figures.

1. Detailed Description of the Figures

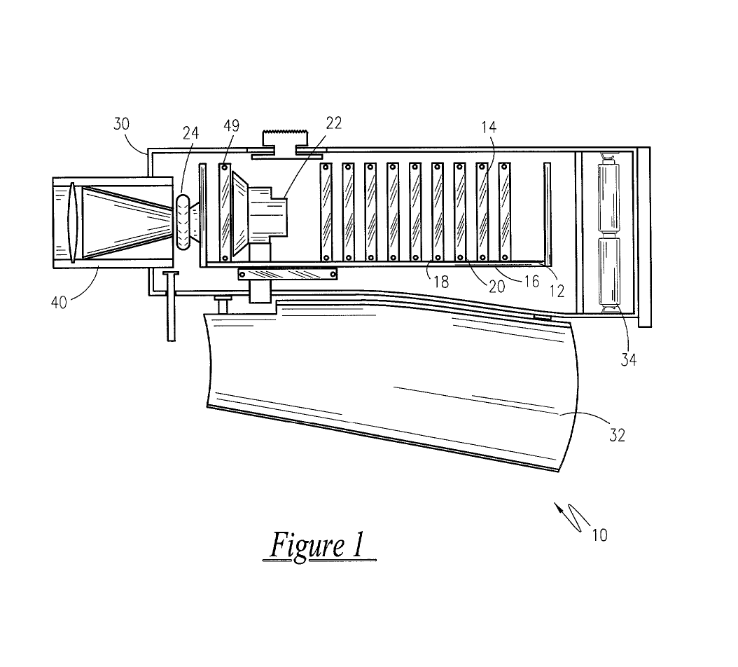

Referring now to FIG. 1, a portable projector 10 including a linear carousel mechanism 12 for retaining a plurality of otherwise conventional projector slides 14. The linear carousel mechanism 12 includes a guide rail 16 that guides and articulates a plurality of slide gripping brackets 18 that are spring urged by a slide advance spring 20 tracked between each respective gripping bracket 18 along the guide rail 16. Each respective slide 14 is articulated and urged forward toward a projector lamp 22 near a projection lens means 24 toward the front of a housing 30. A housing access door 32 is pivotally affixed to the housing 30 such as to open in a clam-shell type manner to provide access to the housing internal cavity.

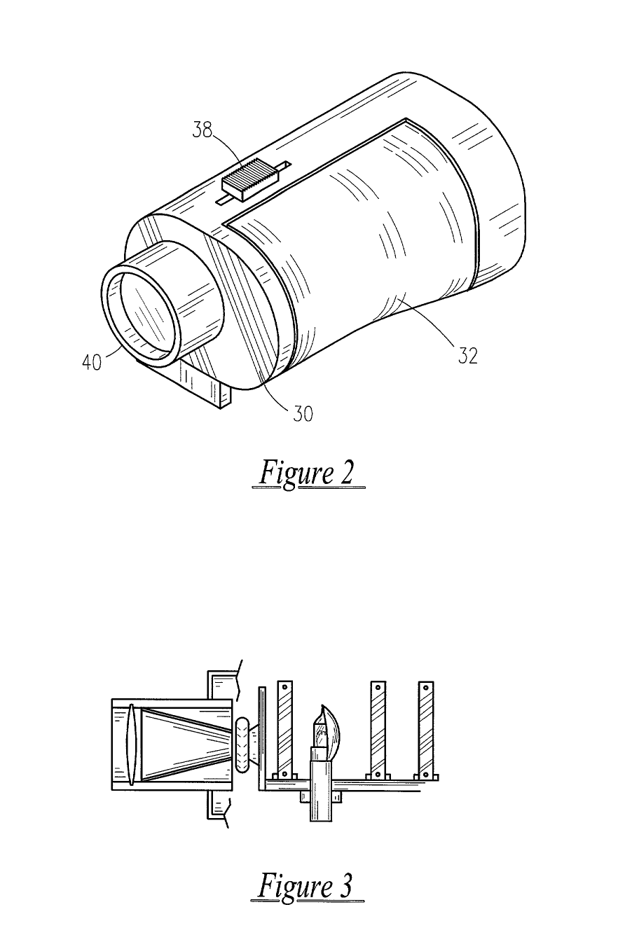

Referring to FIG. 2, the exterior of the housing 30 of the portable projector 10 is shown in greater detail. The housing 30 has an overall size, shape and function of a flashlight. A rechargeable battery pack 34 in the rear of the housing provides power to the lamp assembly 22 as controlled through a switch 38. Various fixed lenses as well as an adjustable focusing lense 40 then allows the image of the slide to be projected onto any flat surface.

FIG. 3 shows in detail the placement of the projection lamp 22 relative to the slides 14. The lamp assembly 24 is pivotally articulated to the rail 12 in such a manner that it can be pivoted up into position between the lead slide 14 and the next available slide in the carousel. In this manner, the lamp can cast the image on the slide toward the lens assembly 24 for projection. As the lamp assembly 24 is pivoted out of the linear track of the slides, a new slide is urged forward by spring action and the old slide is discharged. It is anticipated that the discharged slide 14a will then be returned to the carousel at the end of the track 12.

2. Operation of the Preferred Embodiment

In operation, the present invention provides a means by which photographic slides can be projected quickly and instantly virtually anywhere. The hand manipulatable, portable housing 30 is sized such as to be easily portable, easily handled and directed, and easily loaded with conventional projection slide medium. This is aided by a linear tracking carousel mechanism that advances the slides one at a time.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

What is claimed is:

1. A portable projector comprising:
a housing having a generally tubular, portable shape the overall size and shape of a conventional flashlight; and
slide projection means mounted within said housing for projected a slide image from a lens mounted on a anterior end of said housing.

2. The portable projector of claim 1, wherein said slide projection means comprises a linear carousel mechanism for retaining a plurality of otherwise conventional projector slides.

3. The portable projector of claim 2, wherein said linear carousel mechanism includes a guide rail that guides and articulates a plurality of slide gripping brackets that are spring urged by a slide advance spring tracked between each respective gripping bracket along said guide rail.

4. The portable projector of claim 3, wherein each respective slide is articulated and urged forward toward a projector lamp near a projection lens means toward the front of said housing.

5. The portable projector of claim 1, wherein said housing further comprises an access door pivotally affixed to said housing such as to open in a clam-shell type manner to provide access to a housing internal cavity.

6. The portable projector of claim 4, wherein said lamp assembly is pivotally articulated to said rail in such a manner that it can be pivoted up into position between a lead slide and a next available slide in said carousel, and as a new slide is urged forward by spring action an old slide is discharged.
